(19) United States
(12) Patent Application Publication
(10) Pub. No.: US 2009/0196339 A1
(43) Pub. Date: Aug. 6, 2009

(54) TRANSCODING APPARATUS AND TRANSCODING METHOD

(75) Inventor: Hirotada Hirabayashi, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/356,296

(22) Filed: Jan. 20, 2009

(30) Foreign Application Priority Data
Jan. 31, 2008 (JP) 2008-022003

(51) Int. Cl. H04N 7/26

(52) U.S. Cl. 375/240.01; 375/E07.198

(57) ABSTRACT

According to one embodiment, a transcoding apparatus includes an acquisition module configure to acquire one or more pieces of setting data each including a profile and information on a genre of video content made public on a network, the profile including information on a compression codec, bit rate, and resolution pertaining to transcoding of the video content, and a transcoding module configure to transcode video content based on the profile included in one piece of setting data selected from the setting data acquired.

### CROSS-REFERENCE TO RELATED APPLICATIONS

This application is based upon and claims the benefit of priority from Japanese Patent Application No. 2008-022003, filed Jan. 31, 2008, the entire contents of which are incorporated herein by reference.

### BACKGROUND

1. Field

One embodiment of the invention relates to a transcoding apparatus and a transcoding method for transcoding content that is compression-coded.

2. Description of the Related Art

Recently, acquired content has often been transcoded by a computer or the like for reproduction by a portable device or the like.

Transcoding takes a considerably long time without a powerful computer. Satisfactory outcomes are rather difficult to achieve, requiring much trial and error. Optimum settings also vary with the genre of the input source (such as drama, sport, and cartoon show) and with the output purpose.

Jpn. Pat. Appln. Publication No. 2007-13602 has disclosed a technique for storing a codec and a profile into a removable medium for transcoding.

By virtue of using a removable medium, the foregoing technique is basically limited to an exchange between individuals or acquaintances, and to distribution of a CD-ROM or other optical medium in publishing media.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing transcoding apparatuses and a server according to an embodiment of the present invention;

FIG. 2 is an exemplary block diagram showing the system configuration of the transcoding apparatuses and the server;

FIG. 3 is an exemplary diagram showing an example of a list of setting data to be displayed by a setting data list view module shown in FIG. 2;

FIG. 4 is an exemplary flowchart showing the procedure of transcoding and uploading of setting data; and

FIG. 5 is an exemplary flowchart showing the procedure of processing for performing transcoding by using transcode setting data uploaded to the server.

### DETAILED DESCRIPTION

Various embodiments according to the invention will be described hereinafter with reference to the accompanying drawings. In general, according to one embodiment of the invention, a transcoding apparatus comprises an acquisition module configure to acquire one or more pieces of setting data each including a profile and information on a genre of video content made public on a network, the profile including information on a compression codec, bit rate, and resolution pertaining to transcoding of the video content, and a transcoding module configure to transcode video content based on the profile included in one piece of setting data selected from the setting data acquired.

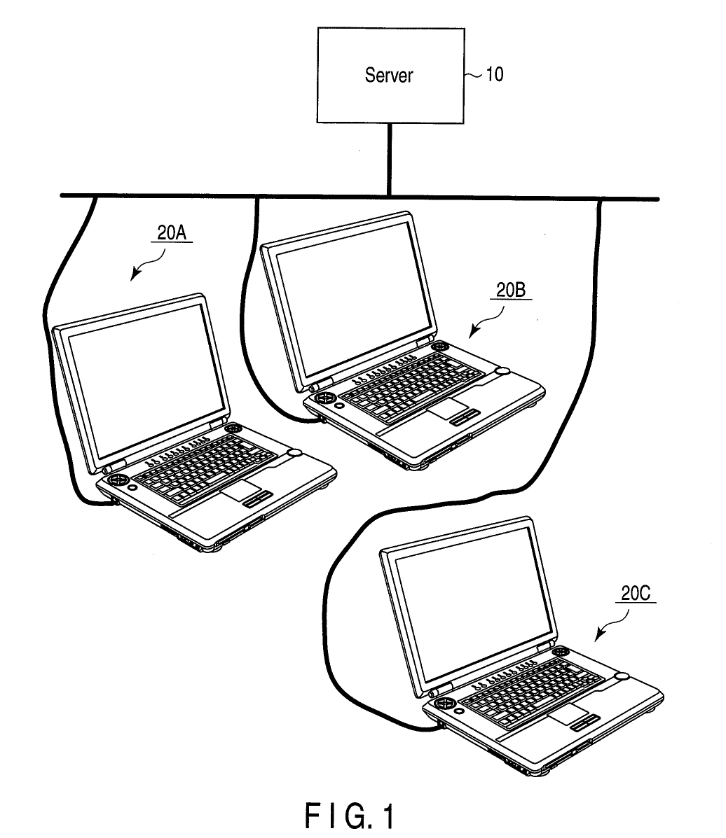

FIG. 1 is a block diagram showing transcoding apparatuses 20A to 20C and a server 10 according to the embodiment of the present invention.

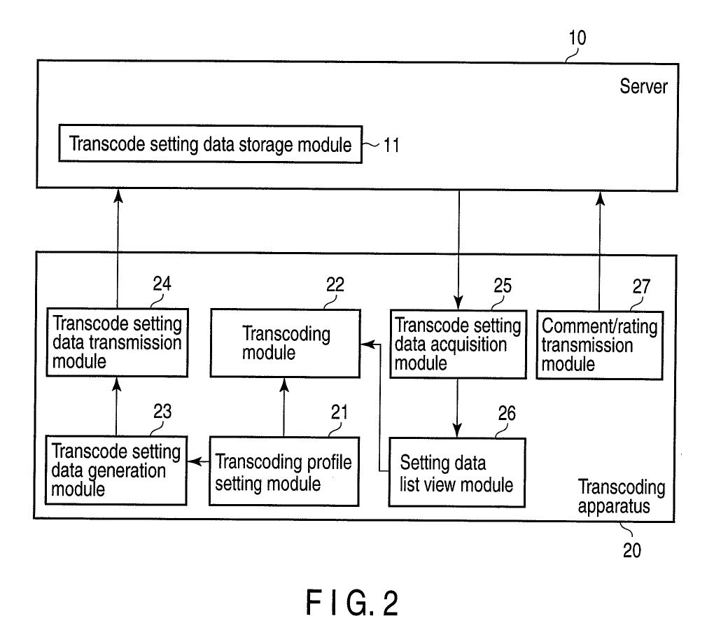

As shown in FIG. 1, a plurality of transcoding apparatuses (notebook type personal computer) 20, and the server 10 are connected with a network. As shown in FIG. 2, each transcoding apparatus 20 has a transcoding profile setting module 21, a transcoding module 22, a transcode setting data generation module 23, a transcode setting data transmission module 24, a transcode setting data acquisition module 25, a setting data list view module 26, a comment/rating transmission module 27, and so on.

When profile (parameter) values pertaining to transcoding are input by a user, the transcoding profile setting module 21 detects the input values.

The transcoding module 22 transcodes video content in accordance with the profile that is input to the transcoding profile setting module 21. Transcoding is performed based on the profile set by the user or setting data created by other users.

The transcode setting data generation module 23 creates setting data when video content is transcoded by using no setting data. The setting data includes: a profile pertaining to video encoding, such as a compression codec, bit rate, and resolution; a profile pertaining to audio encoding, such as a compression codec, bit rate, and sampling rate; a system format for video-audio multiplexing; metadata such as the title, broadcast date and time, and broadcast station name of the content before transcoding; and text data such as comments.

Comments by the creator of the original setting data and comments and ratings by users who have used the setting data may be embedded in the text data. To embed the comments and ratings by the users who have used the setting data, the users send the comments and ratings to the server 10. The server 10 then embeds the comments and ratings into the setting data.

The transcode setting data transmission module 24 transmits the setting data created by the transmission setting data generation module 23 to the server 10 based on a user instruction. The setting data is typically transmitted when the reproduction of the transcoded content results in satisfactory quality.

The transcode setting data acquisition module 25 acquires a plurality of pieces of setting data stored in the server 10 in accordance with a user instruction.

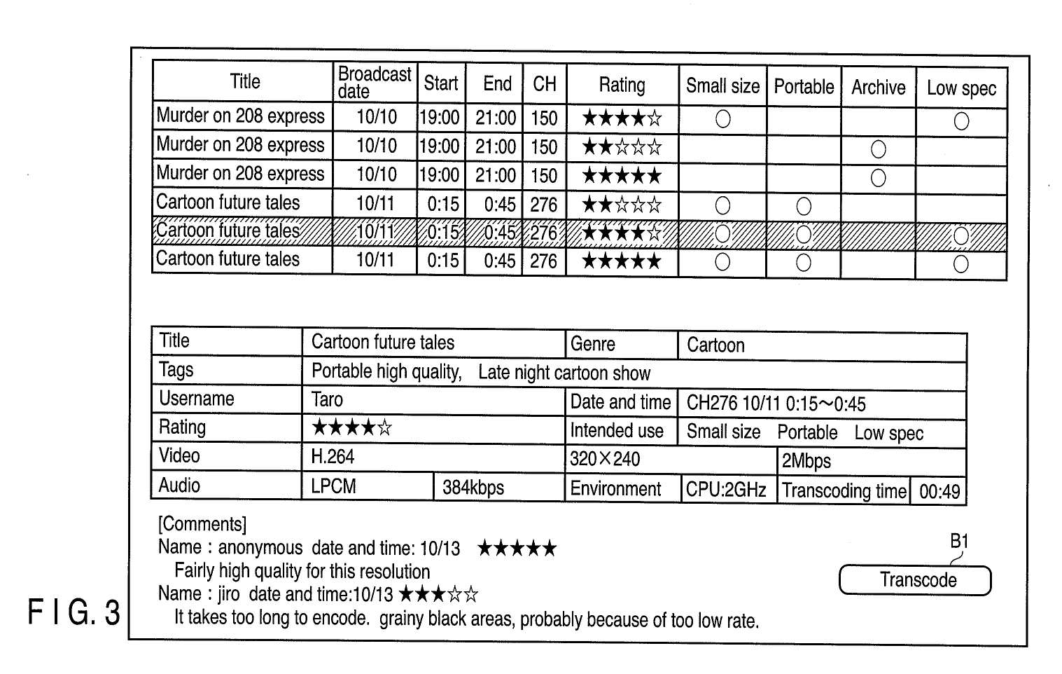

The setting data list view module 26 displays the profiles and metadata about the acquired setting data on a display screen. FIG. 3 shows an example of display of the setting data. As shown in FIG. 3, the setting data contains a title, broadcast date, start (time), end (time), channel (broadcast station), rating (in five levels), and use purpose (small size, portable, archive, low spec) fields, in which respective corresponding items are displayed.

The fifth row from the top is lightly shaded in the background. This indicates the selection by the user, and the setting data selected is displayed in detail under the list.

The details of the setting data include: title; genre; tags; username; (broadcast) date and time; rating (in five levels); intended uses; video format (H.264), resolution (320×240), and bit rate (2 Mbps) used for transcoding; audio format (LPCM) and bit rate (384 kbps) used for transcoding; environment (CPU: 2 GHz); and transcoding time. Comments by other users are displayed below.

A transcode button B1 is also displayed. The transcoding of content is performed when the user points to the transcode button B1 and clicks the L button, virtually operating the transcode button B1. Specification of content to be transcoded may be carried out before or after the button operation.

When the setting data stored in the server 10 is used to transcode content, the user creates comments and rating as to the result of reproduction of the transcoded content. The comment/rating transmission module 27 transmits the comments and rating to the server 10. The server 10, as described above, adds the received comments and rating to the setting data. Incidentally, the rating is averaged with previously-transmitted ratings, and the average value is added as the rating.

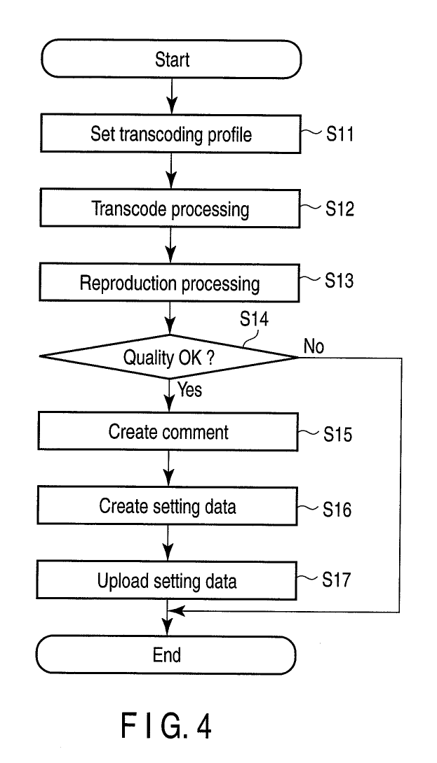

The procedure of the transcoding and the uploading of the setting data will be described with reference to FIG. 4.

The transcoding profile setting module 21 detects a profile input by the user, including a video format, resolution, bit rate (video), audio format, and bit rate (audio) to be used for transcoding (block S11). The transcoding profile setting module 21 detects numerical values or the like that are input by the user from a keyboard or the like.

The transcoding module 22 performs transcode processing of the content based on the profile that is detected in block S11 by the transcoding profile setting module 21 (block S12). The user performs reproduction processing of the transcoded content (block S13). Incidentally, the reproduction processing is desirably performed with a device that the user intends to reproduce the transcoded content with.

The user views the reproduced content, and determines whether or not the quality is satisfactory. The determination is then input to the transcode setting data generation module 23. The transcode setting data generation module 23 determines whether or not the input result is satisfactory (block S14).

If it is determined to be satisfactory (YES in block S14), the transcode setting data generation module 23 displays on-screen user input fields for user's comments and the like to be input (block S15). Except for comments, these user input fields include ones for describing use items and tags. When the user finishes inputting, the transcode setting data generation module 23 creates transcode setting data which includes the profile set in block S11, the metadata concerning the original content such as broadcast date and time, and the user input items (block S16). The setting data created is uploaded to the server 10 by the transcode setting data transmission module 24 (block S17). The transcode setting data uploaded is stored in the transcode setting data storage module 11 of the server 10.

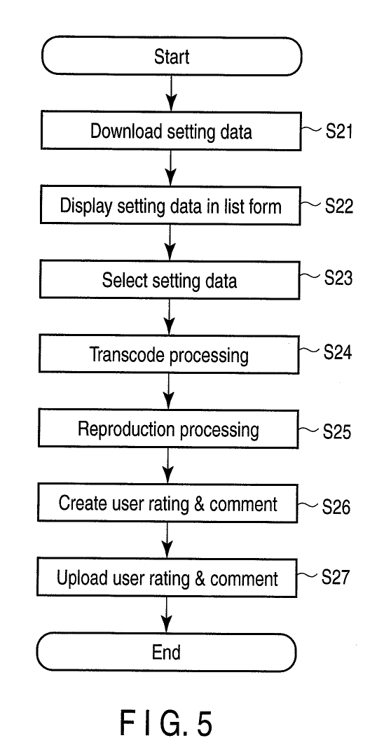

Next, referring to the flowchart of FIG. 5, description will be given of the procedure of processing for performing transcoding by using transcode setting data uploaded to the server 10.

Initially, the transcode setting data acquisition module 25 acquires a plurality of pieces of transcode setting data from the transcode setting data storage module 11 of the server 10 (block S21). The setting data list view module 26 displays the setting data in a list form on the LCD as shown in FIG. 3 (block S22). The user selects one of the displayed pieces of setting data from the list and virtually presses the transcode button B1 (block S23). The transcoding module 22 performs the transcode processing of the content by using the profile of the setting data selected (block S24).

Reproduction processing is performed on the transcoded content (block S25). Based on the result of reproduction, the user inputs comments and rating to the comment/rating transmission module 27. The comment/rating transmission module 27 transmits the comments and rating.

Through the foregoing processing, the transcoding can be performed by using the setting data uploaded to the server 10.

This apparatus is configured to exchange setting data including transcoding-related profiles over a network. This makes it possible to use hardware-supported codecs and to use profiles created by unnamed others. The result of trial and error by one user becomes available to others.

Note that the setting data may include information on edit points for cutting out commercials. For example, time stamp information may be used as the information on edit points if the original is digital broadcast content.

Transcoding takes a considerably long time without a powerful computer. Satisfactory outcomes are rather difficult to achieve, requiring much trial and error. Optimum settings also depend on the type of the input source (such as drama, sport, and cartoon show) and the output purpose. According to this apparatus, the user can perform transcoding based on parameters of certain solid ratings. The conversion processing can be performed according to the use purposes in particular, such as for a portable device, for an archival copy, and for a size reduction.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A transcoding apparatus comprising:
an acquisition module configure to acquire at least one set of setting data comprising a profile and information of a genre of a video content on a network, the profile comprising information of a compression codec, a bit rate, and a resolution for transcoding the video content; and
a transcoder configure to transcode the video content based on the profile.

2. The transcoding apparatus of claim 1, wherein the setting data comprises information of a purpose of use provided by a user who created the setting data, such as for a device with substantially small memory capacity, for a portable device, and for a high-quality archival copy.

3. The transcoding apparatus of claim 1, wherein the setting data comprises a title, broadcast date and time, and a broadcast station of the video content.

4. The transcoding apparatus of claim 3, wherein the setting data comprises information for editing the video content.

5. The transcoding apparatus of claim 1, wherein the setting data comprises a comment by a user who used the setting data.

6. The transcoding apparatus of claim 1, wherein the setting data comprises an average of predetermined ratings collected from users who used the setting data.

7. A transcoding method comprising:
acquiring at least one set of setting data comprising a profile and information of a genre of a video content on a network, the profile comprising information of a compression codec, a bit rate, and a resolution for transcoding the video content; and
transcoding the video content based on the profile.

8. The transcoding method of claim 7, wherein the setting data comprises information of a purpose of use provided by a user who created the setting data, such as for a device with substantially small memory capacity, for a portable device, and for a high-quality archival copy.

9. The transcoding method of claim 7, wherein the setting data comprises a title, broadcast date and time, and a broadcast station of the video content.

10. The transcoding method of claim 9, wherein the setting data comprises information for editing the video content.

11. The transcoding method of claim 7, wherein the setting data comprises a comment by a user who used the setting data.

12. The transcoding method of claim 7, wherein the setting data comprises an average of predetermined ratings collected from users who used the setting data.

13. A transcoding method comprising:
setting a profile comprising information on a compression codec, a bit rate, and a resolution for transcoding a video content, and a system format in a first transcoding apparatus;
transcoding the content based on the set profile in the first transcoding apparatus;
creating first setting data comprising the profile, information of the content, and configuration of the transcoding in the first transcoding apparatus;
transmitting the first setting data from the first transcoding apparatus to a server comprising a storage module open to a network, the storage module comprising a second setting data;
acquiring at least one set of setting data from the server by a second transcoding apparatus; and
transcoding the video content based on the profile by the second transcoding apparatus.
